(19) United States
(12) Patent Application Publication
(10) Pub. No.: US 2020/0014823 A1
(43) Pub. Date: Jan. 9, 2020

(54) TELEPROMPTER AND METHOD

(71) Applicant: Shenzhen Bestview Electronic Co.,Ltd, Shenzhen (CN)

(72) Inventor: Qinyuan Chen, SHENZHEN (CN)

(73) Assignee: Shenzhen Bestview Electronic Co.,Ltd

(21) Appl. No.: 16/574,123

(22) Filed: Sep. 18, 2019

(30) Foreign Application Priority Data
Sep. 6, 2019 (CN) 201910844026.7

(51) Int. Cl. H04N 5/222; G06F 3/147; H04N 5/225; G09G 5/34; H04N 5/445

(52) U.S. Cl. CPC H04N 5/2222; G06F 3/147; H04N 5/2253; G09G 2340/0492; H04N 5/44591; G09G 2340/0471; G09G 5/34

(57) ABSTRACT

The present disclosure provides a teleprompter, which comprises reflecting glass and a display device matching with the reflecting glass, a displayed content of the display device is reflected to the reflecting glass so as to be displayed through the reflecting glass, the display device has a wireless communication module, and the display device is in wireless communication with a terminal device through the wireless communication module such that the displayed content of the display device is synchronized with a displayed content of the terminal device. The present disclosure further provides a prompting method. The present disclosure is convenient to connect and is more human-friendly.

### TECHNICAL FIELD

The present disclosure relates to the technical field of display devices, and in particular, to a teleprompter and method.

### BACKGROUND

It should be noted that contents recorded by this section do not all represent the prior art.

A teleprompter displays the content of a script through a high-brightness display device and reflects the displayed content of the display device to a special coated glass at a 45-degree angle in front of the lens of a video camera so as to reflect words, so that a speaker can face to the video camera while watching the speeches. The existing teleprompter is directly connected by using wires, such as VGA, HDMI, AV, SDI and the like, which is inconvenient.

### SUMMARY

In view of this, it is necessary to provide a teleprompter and method, which is convenient to connect and is more human-friendly, in order to solve one of technical problems in the prior art to a certain extent.

A first aspect of the present disclosure provides a teleprompter, which comprises reflecting glass and a display device matching with the reflecting glass, a displayed content of the display device is reflected to the reflecting glass so as to be displayed through the reflecting glass, the display device has a wireless communication module, and the display device is in wireless communication with a terminal device through the wireless communication module such that the displayed content of the display device is synchronized with a displayed content of the terminal device.

Furthermore, a lens hood is mounted on the reflecting glass.

Furthermore, the teleprompter comprises angle adjusters, the angle adjuster is used for adjusting an angle between the reflecting glass and the display device.

Furthermore, slide bars are arranged at the back of the reflecting glass, the slide bars are provided with a mounting element for mounting a video camera, and the mounting element can move along the slide bars so as to adjust a distance between the mounting element and the reflecting glass.

Furthermore, the size of a display interface of the display device is different from the size of a display interface of the terminal device.

A second aspect of the present disclosure provides a prompting method applied to a teleprompter, the teleprompter comprises reflecting glass and a display device, the display device has a wireless communication module, and the method comprises the following steps:

the display device establishes wireless communication with the terminal device through the wireless communication module; and

the display device receives a displayed content of the terminal device such that a displayed content of the display device is synchronized with the displayed content of the terminal device, wherein the display device receives a content, which undergoes mirroring process, of the terminal device, or the display device receives the displayed content of the terminal device and then performs mirroring display.

A third aspect of the present disclosure provides a teleprompter, which comprises a display device, the display device comprises:

a processor; and

a storage device, wherein the storage device contains a processor executable instruction, and the executable instruction is used for performing the prompting method when the processor operates.

A fourth aspect of the present disclosure provides a prompting method applied to a terminal device, the terminal device is used for connecting a teleprompter, the teleprompter comprises reflecting glass and a display device, the display device has a wireless communication module, and the method comprises the following steps:

the terminal device establishes wireless communication with the display device; and

the terminal device transmits a displayed content to the display device such that a displayed content of the display device is synchronized with the displayed content of the terminal device, wherein the terminal device transmits a content, which undergoes mirroring process, to the display device, or the display device receives the displayed content of the terminal device and then performs mirroring display.

Furthermore, the method further comprises:

judging whether received voice information corresponds to currently scrolling text information;

if yes, judging whether a current voice speed matches with a scrolling speed of the currently displayed content; and

if the current voice speed does not match with the scrolling speed of the currently displayed content, adjusting the scrolling speed of the currently displayed content to match with the current voice speed.

Furthermore, the method further comprises:

if the terminal device receives an edition instruction, the terminal device divides a screen display area into at least two split screen areas, and one split screen area is used for displaying a content needing to be prompted while the other split screen area is used for editing the content.

It can be known based on the above solutions: the present disclosure integrates the wireless communication module in the display device of the teleprompter and can perform wireless communication with the terminal device so as to reduce arrangement of wires and improving universality of the teleprompter.

### BRIEF DESCRIPTION OF THE DRAWINGS

FIG. 1 is a schematic structural diagram of a teleprompter of an embodiment of the present disclosure;

FIG. 2 is a schematic diagram of a hardware structure of a display device of the present disclosure;

FIG. 3 is a flowchart of a prompting method of a first embodiment of the present disclosure;

FIG. 4 is a schematic diagram of prompt; and

FIG. 5 is a flowchart of a prompting method of a second embodiment of the present disclosure.

The following specific embodiments will further describe the present disclosure with reference to the accompanying drawings.

### DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure. It can be understood that the accompanying drawings are merely used for providing reference and description, but not limitations to the present disclosure. Connection relationships shown in the accompanying drawings are merely used for facilitating clear description, but are not used to limit connection manners.

It should be noted that: when an element is considered to be “connected” to another element, it can be directly connected to another element or may also have a centered element. Unless otherwise defined, all technical and scientific terms used herein have the same meaning as commonly understood by one of ordinary skilled in the art to which this disclosure pertains. It should be further noted that: unless expressly specified and defined otherwise, the terms “installation”, “connected” and “connection” should be understood broadly. For example, “connection” may be fixed connection, detachable connection or integral connection; may also be mechanical connection or electrical connection; and may also be communication between two elements. Those ordinarily skilled in the art may understand the specific meanings of the above terms in the present disclosure based on specific situations. The terminology used herein in the specification of the present disclosure is for the purpose of describing specific embodiments only and is not intended to limit the present disclosure.

In the description of the present disclosure, it should be further noted that orientations or position relationships indicated by terms “center”, “upper”, “lower”, “left”, “right”, “vertical”, “horizontal”, “inner”, “outer”, etc. are orientations or position relationships as shown in the drawings, and these terms are just used to facilitate description of the present disclosure and simplify the description, but not to indicate or imply that the mentioned apparatus or elements must have a specific orientation and must be established and operated in a specific orientation, and thus, these terms cannot be understood as a limitation to the present disclosure. Furthermore, the terms “first”, “second” and “third” are merely for the purpose of description, but should not be understood as indicating or implying relative importance.

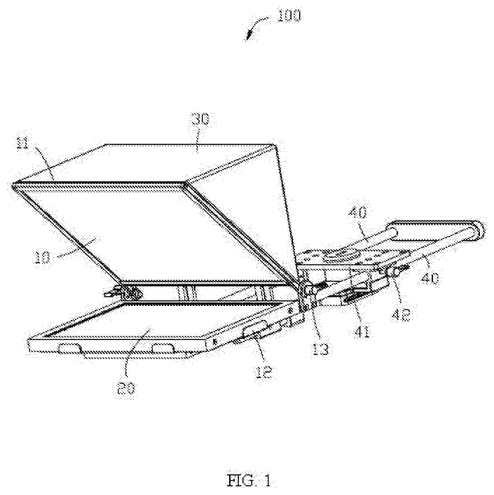

FIG. 1 is a schematic structural diagram of a teleprompter 100 provided by an embodiment of the present disclosure, the teleprompter 100 comprises reflecting glass 10 and a display device 20, the display device 20 has a display screen for displaying a content.

Wherein the display screen faces to the reflecting glass 10 and forms a certain included angle with the reflecting glass 10. In the embodiment, the reflecting glass 10 is fixed by a frame 11, the display device 20 is fixed by a supporting part 12, the frame 11 is connected with angle adjusters 13, the angle adjuster 13 can adjust an angle of the frame 11 so as to be capable of adjusting an angle between the reflecting glass 10 and the display device 20, so the content can be greatly displayed through the reflecting glass 10. When the teleprompter 100 needs to be collected or transported, the angle adjuster 13 is disengaged and the frame 11 is folded.

The frame 11 can be equipped with a lens hood 30 to prevent light from influencing projection of the reflecting glass 10, and a back end of the lens hood 30 can extend in order that a video camera is arranged at one end, away from the reflecting glass 10, of the lens hood 30.

In order to facilitate adjustment of a distance of the video camera relative to the reflecting glass 10 to improve camera effects, slide bars 40 are arranged at the back of the supporting part 12 (namely the back of the reflecting glass 10), the slide bars 40 are provided with a mounting element 41 for mounting a video camera, the mounting element 41 can select a quickly assembled support in order to quickly mount the video camera, and the mounting element 41 can move along the slide bars 40 so as to be capable of changing a distance between the camera and the reflecting glass 10 (or a host). In order to position the mounting element 41 on the slide bars 40, the mounting element 41 can be provided with locking elements 42, and the mounting element 41 can be fixed by adjusting the locking elements 42.

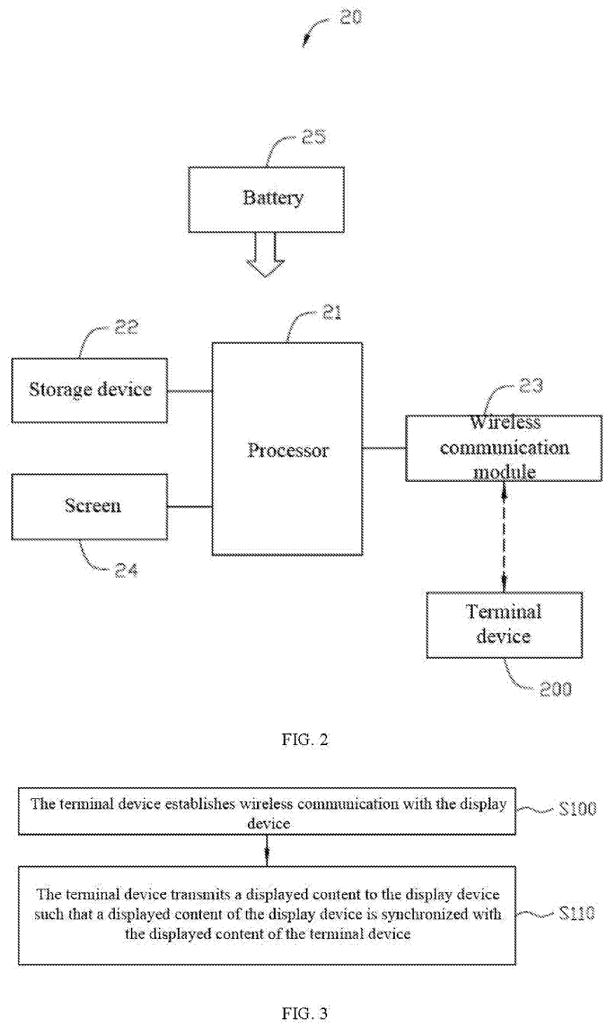

As shown in FIG. 2, the display device 20 comprises a processor 21, a storage device 22 and a wireless communication module 23, and certainly further comprises a screen 24 and a battery 25, the battery 25 is used as an energy source, the wireless communication module 23 is used for performing wireless communication with the terminal device 200 such that the displayed content of the display device 20 is synchronized with the displayed content of the terminal device 200 (for example, content synchronization can be performed in a screen projection manner), and the terminal device 200 prefers a portable terminal device 200 such as a mobile phone, a tablet computer and the like so as to be convenient to carry. The wireless communication module 23 can include but is not limited to a Wi-Fi module, a 3G/4G/5G module and a Bluetooth module.

In the teleprompter 100 of the present disclosure, the size of the display screen of the display device 20 is configured to completely match with the size of the reflecting glass 10, that is, information on the display screen of the display device 20 can be completely and exactly projected onto the reflecting glass 10. The size of the display screen of the display device 20 can be different from the size of the display screen of the terminal device 200.

Compared with a method that the terminal device 200 is directly located at the supporting part 12 of the teleprompter 100 and projects a content to the reflecting glass 10, the present disclosure uses the display device 20 of the teleprompter 100 as the intermediate device such that a projected content continuously keeps complete; the sizes of screens of different terminal devices 200 are different, so, when an oversize terminal device 200 is directly located at the supporting part 12 and then projects the content to the reflecting glass 10, the reflecting glass 10 cannot completely display the content, and when a too small terminal device 200 is directly located at the supporting part 12 and then projects the content to the reflecting glass 10, the displayed content of the reflecting glass 10 is too small; therefore, the teleprompter 100 of the present disclosure can support different types of terminal devices 200.

The display device 20 and the terminal device 200 are in wireless communication, and the displayed content of the display device 20 is synchronized with the displayed content of the terminal device 200, so tedious cable arrangement can be avoided, the display device can be in wireless communication with a portable terminal such as a mobile phone or a tablet computer so as to improve the portability, and different sizes of display screens can completely project the content to the reflecting glass 10.

As shown in FIG. 3, a first embodiment of the present disclosure provides a prompting method which can be applied to the terminal device 200, the terminal device 200 can be connected with the teleprompter 100 provided by the embodiment of the present disclosure, and the method comprises the following steps:

S100: the terminal device 200 establishes wireless communication with the display device 20; and

S110: the terminal device 200 transmits a displayed content to the display device 20 such that a displayed content of the display device 20 is synchronized with the displayed content of the terminal device 200.

In the step S110, the terminal device 200 transmits a content, which undergoes mirroring process, to the display device 20, or the display device 20 receives the displayed content of the terminal device 200 and then performs mirroring display.

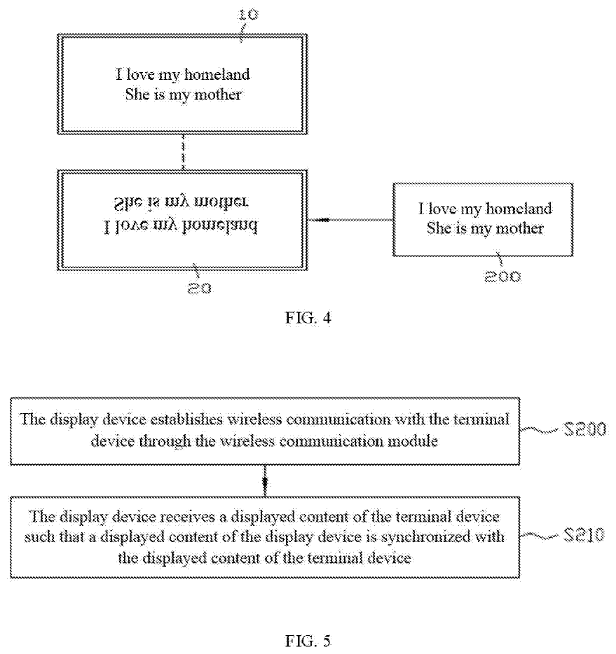

As shown in FIG. 4, an operator holds the terminal device 200 generally in a forward direction when operating the terminal device 200 such that the displayed content of the terminal device 200 is in the forward direction, but if the displayed content does not undergo the mirroring process but is directly displayed through the display device 20, the displayed content is inverted after being projected to the reflecting glass 10 and then is inconvenient to watch by the host.

In the step, the display device 20 receives a content, which undergoes mirroring process, of the terminal device 200, or the display device 20 receives the displayed content of the terminal device 200 and then performs mirroring display. Although the displayed content of the terminal device 200 is forward, the displayed content undergoes the mirror process (wherein the mirroring process can be performed by the terminal device 200 or the display device 20), and then the displayed content of the display device 20 is inverted, so the displayed content is forward after being projected to the reflecting glass 10 and then is convenient to watch by the host.

The prompting method provided by the embodiment can further comprise the following steps:

S220: judging whether received voice information corresponds to currently scrolling text information; if yes, performing the step S230; and if no, completing the flow.

The step S220 can be performed after the step S210. It can be understood that: if the received voice information is inconsistent with the currently scrolling text information, it represents that the host broadcasts the other content, and the scrolling can be stopped to wait for continuous prompting after the host completes the broadcasting of the other content.

S230: judging whether a current voice speed matches with a scrolling speed of the currently displayed content; if yes, completing the flow; and if no, performing the step S240.

S240: adjusting the scrolling speed of the currently displayed content to match with the current voice speed.

It can be known from steps S220 to S240: when a broadcast content of the host corresponds to the currently scrolling text information, it judges whether the current voice speed matches with the scrolling speed of the currently displayed content; and if no, it represents that the scrolling speed is too high or too low, and such scrolling speed cannot effectively achieve prompting effects and influences broadcasting effects of the host, so the scrolling speed needs to be adjusted to match with the current voice speed, for example, the scrolling speed is adjusted to match with the speech speed of the host, which is more beneficial to improving the broadcasting effects of the host.

The prompting method provided by the embodiment can further comprise the following steps:

S250: if the terminal device 200 receives an edition instruction, the terminal device 200 divides a screen display area into at least two split screen areas, and one split screen area is used for displaying a content needing to be prompted while the other split screen area is used for editing the content,

which is specifically shown in FIG. 6. If the terminal device 200 receives an edition instruction, content edition needs to be performed on the terminal device 200, for example, a broadcasting content (which is a content to be broadcast by the host) or a prompting content (which is a content to prompt the host) can be added, and the content scrolling exits when the content is edited such that the content cannot be prompted, which is adverse to continuous broadcasting of the host. By the step S250, the content can be continuously prompted, and the operator can edit the content on the terminal device 200, so that the present disclosure has great practicability, is more human-friendly and is more beneficial to the broadcasting of the host.

As shown in FIG. 5, a second embodiment of the present disclosure provides a prompting method which can be applied to the teleprompter 100 provided by the embodiment of the present disclosure, and the method comprises the following steps: it should be understood that: each specific technical solution in the first embodiment can be correspondingly applied to the embodiment.

S200: the display device 20 establishes wireless communication with the terminal device 200 through the wireless communication module 23; and

S210: the display device 20 receives a displayed content of the terminal device 200 such that a displayed content of the display device 20 is synchronized with the displayed content of the terminal device 200.

In the step S210, the display device 20 receives a content, which undergoes mirroring process, of the terminal device 200, or the display device 20 receives the displayed content of the terminal device 200 and then performs mirroring display. The beneficial effects can refer to the prompting method of the first embodiment, which is not described herein.

An embodiment of the present disclosure further provides a teleprompter 100, the teleprompter 100 comprises a display device, the display device comprises a processor and a storage device, the storage device contains a processor executable instruction, and the executable instruction is used for performing the prompting method when the processor operates.

The above merely describes preferred embodiments of the present disclosure, but are not used to limit the present disclosure. Any modifications, equivalent replacements, improvements and the like within the spirit and principle of the present disclosure shall be all contained in the protection scope of the present disclosure.

What is claimed is:

1. A teleprompter, comprising reflecting glass and a display device matching with the reflecting glass, wherein a displayed content of the display device is reflected to the reflecting glass so as to be displayed through the reflecting glass; the display device has a wireless communication module, and the display device is in wireless communication with a terminal device through the wireless communication module such that the displayed content of the display device is synchronized with a displayed content of the terminal device.

2. The teleprompter according to claim 1, wherein a lens hood is mounted on the reflecting glass.

3. The teleprompter according to claim 1, wherein the teleprompter comprises angle adjusters, and the angle adjuster is used for adjusting an angle between the reflecting glass and the display device.

4. The teleprompter according to claim 1, wherein slide bars are arranged at the back of the reflecting glass, the slide bars are provided with a mounting part for mounting a video camera, and the mounting part can move along the slide bars so as to adjust a distance between the mounting part and the reflecting glass.

5. The teleprompter according to claim 1, wherein the size of a display interface of the display device is different from the size of a display interface of the terminal device.

6. A prompting method, which is applied to a teleprompter comprising reflecting glass and a display device, wherein the display device has a wireless communication module, and the method comprises the following steps:
the display device establishes wireless communication with the terminal device through the wireless communication module; and
the display device receives a displayed content of the terminal device such that a displayed content of the display device is synchronized with the displayed content of the terminal device, wherein the display device receives a content, which undergoes mirroring process, of the terminal device, or the display device receives the displayed content of the terminal device and then performs mirroring display.

7. A teleprompter, comprising a display device, wherein the display device comprises:
a processor; and
a storage device, wherein the storage device contains a processor executable instruction, and the executable instruction is used for performing the prompting method according to claim 6 when the processor operates.

8. A prompting method, which is applied to a terminal device for connecting a teleprompter which comprises reflecting glass and a display device, wherein the display device has a wireless communication module, and the method comprises the following steps:
the terminal device establishes wireless communication with the display device; and
the terminal device transmits a displayed content to the display device such that a displayed content of the display device is synchronized with the displayed content of the terminal device, wherein the terminal device transmits a content, which undergoes mirroring process, to the display device, or the display device receives the displayed content of the terminal device and then performs mirroring display.

9. The prompting method according to claim 8, wherein the method further comprises:
judging whether received voice information corresponds to currently scrolling text information;
if yes, judging whether a current voice speed matches with a scrolling speed of the currently displayed content; and
if the current voice speed does not match with the scrolling speed of the currently displayed content, adjusting the scrolling speed of the currently displayed content to match with the current voice speed.

10. The prompting method according to claim 8, wherein the method further comprises:
if the terminal device receives an edition instruction, the terminal device divides a screen display area into at least two split screen areas, and one split screen area is used for displaying a content needing to be prompted while the other split screen area is used for editing the content.
